(19) United States
(12) Patent Application Publication
(10) Pub. No.: US 2005/0105119 A1
(43) Pub. Date: May 19, 2005

(54) Easy scan kiosk for low volume document scanner

(76) Inventors: Carl J. Tesavis, Spencerport, NY (US); Emil Cost, Honeoye Falls, NY (US); Gregory S. Mischler, Webster, NY (US); Alessandra Paris, Rochester, NY (US)

Correspondence Address: Mark G. Bocchetti;Patent Legal Staff, Eastman Kodak Company, 343 State Street, Rochester, NY, 14650-2201, US

(21) Appl. No.: 10/696,264

(22) Filed: Oct. 29, 2003

(51) Int. Cl. G06F 3/06; H04N 1/04; G06F 7/04; G08B 29/00; G06K 19/00; G06K 1/00

(52) U.S. Cl. 358/1.14; 713/182; 340/5.6; 340/5.81; 358/474

(57) ABSTRACT

A method for storing scanned document on a media (80) includes coding a personal identification number (PIN) to the media, the media is then inserted into a scanner (70). The PIN is verified and the scanner is activated. At least one document can be scanned. The scanned documents are then stored on the media.

### FIELD OF THE INVENTION

This invention relates to production document scanning services provided for a retail environment.

### BACKGROUND OF THE INVENTION

Currently the only access consumers have to low volume production scanners is by means of a scanning service business. Most retail consumers are unaware of such services and additionally do not want to relinquish control of their personal documents to a service provider. It is desirable to provide a high speed scanner in a retail location which is easy to operate, capable of writing a large volume of information to a storage media, and easy for the retailer to sell the service and authorize operation of the scanner.

### SUMMARY OF THE INVENTION

Briefly, according to one aspect of the present invention, a method for storing scanned document on a media includes coding a personal identification number (PIN) to the media, the media is then inserted into a scanner. The PIN is verified and the scanner is activated. At least one document can be scanned. The scanned documents are then stored on the media.

This invention is to enable consumer access to the speed and capabilities of a high speed scanner in a retail setting. Scanners are priced at a point which would prohibit most consumer level customers from purchasing the hardware directly. The present invention provides customers the capability of using the speed and accuracy of the scanner to assist them in archiving and providing electronic copies of their valuable photos and documents. This access can be provided by means of the scan base and scanner available at convenient retailer locations, such as Kinkos, Mail Boxes etc., copy service companies, convenience stores, etc.

The base is low profile (i.e. less than 2″ high) and takes up a minimum of retailer counter space by allowing the scanner to be positioned on top of the base. The interface presented to the user provides a simple three-button control for the scanner (i.e., scan photo, scan document, stop). The invention also includes a viewing interface to allow the user to preview the images being written to CD. In an alternate embodiment, the viewing interface includes a touch screen and which provides a platform to build a more complex interface below the simple control interface and provide access to all standard driver interface for document scanning, otherwise known as TWAIN controls. In yet another embodiment, the CD writer interface is designed to only accept CD's containing a globally unique identifier (GUID), sometimes referred to as a personal identification number (PIN). The retailer sells the CD or alternate writable media to the consumer who then is authorized to use any of those retailers' scanners until the CD or alternate writable media is full.

The system design supports multiple marketing schemes wherein, for example, a set of GUIDs could be used on any Walmart, Wegmans, and K-Mart scanner, but Kinkos could restrict access such that only CD's sold by them would work only in their scanners. Retailers will require this feature because they will not want discount retailers selling CD's at a lower price and having them used on their equipment. If a scheme like this is not employed the revenue sharing mechanism would be complex and would dissuade many retailers from participating.

The invention and its objects and advantages will become more apparent in the detailed description of the preferred embodiment presented below.

### BRIEF DESCRIPTION OF THE DRAWINGS

FIG. 1 represents a scanner according to the present invention.

FIG. 2 represents a globally unique identifier (GUID) layout.

### DETAILED DESCRIPTION OF THE INVENTION

The present invention will be directed in particular to elements forming part of, or in cooperation more directly with the apparatus in accordance with the present invention. It is to be understood that elements not specifically shown or described may take various forms well known to those skilled in the art.

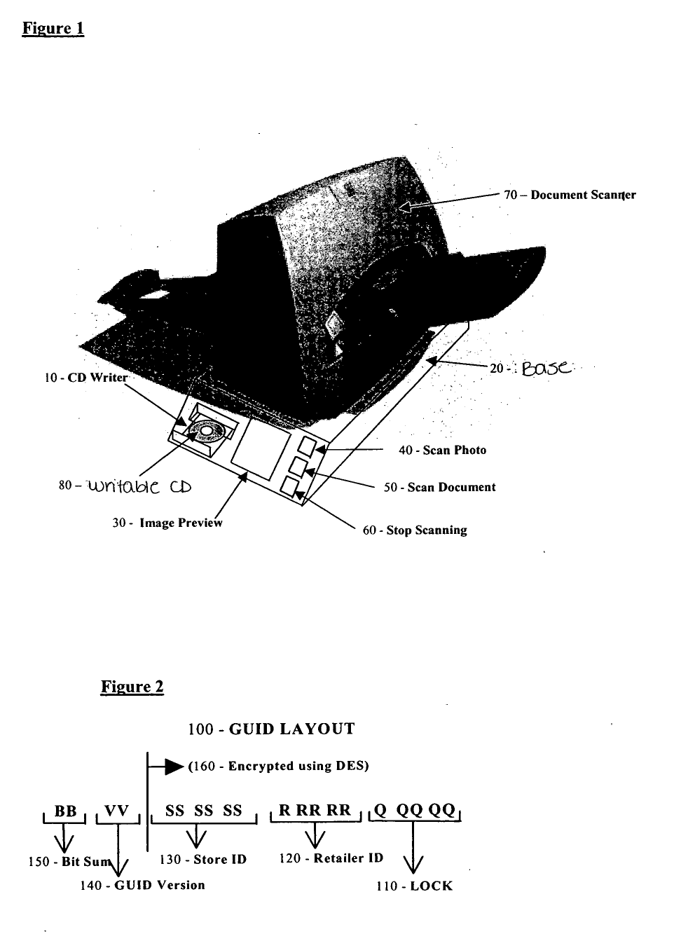

Referring now to FIG. 1 the base 20 is comprised of a low profile box with a sloping front end presenting the user interface. The focus of the user interface is simplicity. There are a minimum of user controls (buttons 40, 50, 60). In a simple form, three buttons, an image preview device 30, and a write once CD drive 10 comprise the interface. The three buttons (40, 50, 60) include two scan enable buttons 40 and 50 providing the scanner the following setup. The scan photo button 40 would enable the scanner with the following settings:
1) simplex mode
2) auto crop and deskew
3) color table would be the table which produced the best electronic renditions of photo type originals
4) resolution would be 300 dpi
5) the compression setting would be JPEG BEST

The scan document button 50 would enable the scanner with the following settings:
1) duplex mode
2) auto crop and deskew
3) color table would be mixed
4) resolution would be 200 dpi
5) dual stream binarized output would be selected
6) compression would be a medium setting

In this embodiment the interface would provide the end-user a high degree of simplification as compared to presenting them with the complete TWAIN interface. The base 20 will contain an embedded “headless” central processing unit (CPU) board. The CPU will include the 1394 or similar interface to the document scanner 70, the intelligent drive electronics (IDE) interface to the CD writer 10, and the user interface (30-60) previously described. A point of sale touch screen PC could also provide this functionality, which would be advantageous if you desired to expose more of the TWAIN interface for more advanced users.

A custom software application running on the embedded CPU, uses the existing driver to control the scanner. The software preferably uses a Windows application, which includes audio prompts to the user and controls the scanner from the inputs of the user interface. The software also manages the CD writer 10 and limit access to the scanner to possessing the CD's 80 with legitimate GUID's 100. This will require decryption 160 software and an input of a list of legitimate encryption keys.

The present invention provides for a business case, which would include the revenue from the sales and service of the base hardware plus the consumable writable CD 80. These CD's 80 would include a sophisticated GUID 100, see FIG. 2, which would be virtually impossible to decrypt. The GUID 100 would provide the retailer a secure means to limit access of their scanners to consumers who purchased the CD 80 from their inventory or they could allow any CD 80 with a valid GUID 100 to work in their document scanner 70 depending on their business model. This scheme provides the retailer and distributor a secure stream of income from consumer use of their scanners.

GUID 100 Definition Relating to FIG. 2

bit sum 150, the unsigned sum of the binary GUID data including GUID version, retailer ID, store ID and lock (8 bits binary). The bit sum is calculated after encryption but prior to conversion to the ASCII representation. The purpose of this bit sum is to identify data entry errors.
GUID version 140, revision number of this GUID number (8 bits binary). This maps to the encryption key, a new version should accompany any change in the key.
store ID 130, unique store identifier within the retailer chains (24 bits binary).
retailer ID 120, unique retailer identifier (20 bits binary).
lock 110, a piece of data read from the CD-R's 80 identifier fields (20 bits binary). The purpose of this field is to prevent a person attempting to use the service illegally by copying an empty purchased CD 80, including the GUID 100, to any number of empty CD-R's 80. This feature makes copying difficult. Each writable CD 80 has a track with identifier fields describing the manufacture and type of CD 80. The CD's 80 used in this system would not be sold to consumers for general use. A piece of this identifier data would be included in the encrypted portion of the GUID 100. When the GUID 100 was decrypted by the scan base 20 at validation time, the disk identifier data read from the disk would be compared with the lock 110 portion of the GUID 100. If it did not compare the CD 80 would not work and an audible tone would be sounded and the CD 80 retained in the drive.

The actual GUID 100 will be created from the binary representation of the bit sum 150, GUID version 140, retailer ID 120, store ID 130, and the lock 110 as shown in FIG. 2. Note the GUID version 150 and bit sum 140 must not be encrypted 160.

The GUID 100, minus the bit sum 150 and version 140, will be encrypted prior to conversion to ASCII form by using data encryption standard (DES) 160 functions with a 56 bit key. The keys will be non-obvious and known to the CD 80 manufacturer. They will be provided to valid retailer sites when changed. A change to the key will map to a new GUID version 140. This will allow the GUID's 100 to be reconstituted and the encryption 160 changed if a security breach is detected.

The GUID 100 will be presented as 16 case insensitive alphanumeric ASCII typeable characters (i.e., 10 byte binary GUID represented in base 32 using 0-9 and As-Vv where 0=0, 1=1, Aa=10, . . . , Vv=31).

The invention has been described in detail with particular reference to certain preferred embodiments thereof, but it will be understood that variations and modifications can be effected within the scope of the invention.

### Parts List

10 CD writer
20 base
30 image preview device
40 scan photo button
50 scan document button
60 stop scanning button
70 document scanner
80 writable CD or alternate writable media
100 globally unique identifier (GUID) layout
110 lock
120 retailer ID
130 store ID
140 GUID version
150 bit sum
160 encrypted portion of GUID

1. A method for storing scanned documents to a media comprising:
coding a personal identification number (PIN) onto said media;
inserting said media into a scanner;
verifying said personal identification and activating said scanner;
scanning at least one document; and
storing said scanned documents on said media.

2. A method as in claim 1 wherein said coding includes a manufacturer's identification.

3. A method as in claim 1 wherein said coding includes a retailer's identification.

4. A method as in claim 1 wherein said coding includes store identification.

5. A method as in claim 1 wherein said coding includes a manufacturer's identification, retailer's identification, and store identification.

6. A method as in claim 1 wherein said coding includes an encrypted portion and an unencrypted portion.

7. A method for storing scanned documents to a media comprising:
coding a personal identification number (PIN) on to said storage media;
decoding said personal identification number;
authorizing a scanning operation based on said personal identification number;
scanning at least one document; and
storing said scanned documents onto said media.

8. A method for storing scanned documents to a media comprising:
coding a first personal identification number (PIN) onto said storage media at a media manufacturing location;
coding a second personal identification number onto said storage media at a retailer location;
decoding said personal identification number on a scanner;
authorizing a scanning operation based on said personal identification number;
scanning at least one document; and
storing said scanned documents onto said media.

9. A method for collecting money for scanning documents to a media comprising:
coding a personal identification number (PIN) onto said storage media;
selling said storage media to a customer;
decoding said personal identification number at a scanner;
authorizing a scanning operation based on said personal identification number;
scanning at least one document; and
storing said scanned documents onto said media.

10. A method for collecting money for scanning documents to a media comprising:
coding a personal identification number (PIN) onto said storage media;
selling said storage media to a customer;
decoding said personal identification number at a scanner;
scanning at least one document; and
authorizing storing said scanned document onto said media 80 based on said personal identification number.

11. A media for storing images and authorizing operation of a scanner comprising:
wherein said media is adapted to record digital information; a personal identification number (PIN) encoded on said media; and
wherein said personal identification code authorizes operation of said scanner.

12. A scanner comprising:
a reader for reading information contained on a media; a microprocessor for verifying a personal identification number (PIN) contained on said media and authorizing operation of said scanner; and
a writer for writing scanned information onto said media.
